(19) United States
(12) Patent Application Publication
(10) Pub. No.: US 2026/0196485 A1
(43) Pub. Date: Jul. 9, 2026

(54) PRECURSOR OF CATHODE ACTIVE MATERIAL

(71) Applicant: TOYOTA JIDOSHA KABUSHIKI KAISHA, Toyota-shi (JP)

(72) Inventor: Momoko PROCTER, Seto-shi (JP)

(73) Assignee: TOYOTA JIDOSHA KABUSHIKI KAISHA, Toyota-shi (JP)

(21) Appl. No.: 19/387,786

(22) Filed: Nov. 13, 2025

(30) Foreign Application Priority Data
Jan. 9, 2025 (JP) 2025-003187

(51) Int. Cl. H01M 4/36; H01M 4/02; H01M 4/525; H01M 4/62

(52) U.S. Cl. CPC H01M 4/366; H01M 4/525; H01M 4/62; H01M 2004/021

(57) ABSTRACT

A precursor of a cathode active material includes secondary particles each including a plurality of primary particles aggregated together. The primary particles include a nickel composite hydroxide. The precursor includes, on at least a portion of the outermost surface of each of the primary particles as observed with a transmission electron microscope, a layer of a rock salt structure containing nickel oxide.

### CROSS-REFERENCE TO RELATED APPLICATION

This application claims priority to Japanese Patent Application No. 2025-003187 filed on Jan. 9, 2025. The disclosure of the above-identified application, including the specification, drawings, and claims, is incorporated by reference herein in its entirety.

### BACKGROUND

### 1. Technical Field

The present disclosure relates to precursors of cathode active materials.

### 2. Description of Related Art

Various techniques have been proposed regarding cathode active materials such as those disclosed in Japanese Unexamined Patent Application Publication No. 2024-86748 (JP 2024-86748 A), Japanese Unexamined Patent Application Publication (Translation of PCT Application) 2022-544326 (JP 2022-544326 A), and Japanese Unexamined Patent Application Publication No. 2012-18925 (JP 2012-18925 A).

### SUMMARY

Conventionally, various cathode active materials have been proposed in order to obtain a cathode having excellent battery characteristics such as high cycle characteristics and high output characteristics.

For example, JP 2024-86748 A discloses particles of a transition metal composite hydroxide containing a transition metal and an additive element, which are used as a precursor of a cathode active material. The particles include secondary particles each formed by aggregation of a plurality of primary particles. Each secondary particle has a central portion and a peripheral portion, and the additive element is contained at a higher concentration in the central portion than in the peripheral portion. In the particles of the transition metal composite hydroxide disclosed in JP 2024-86748 A, both the central portion and the peripheral portion of each secondary particle are composed of hydroxide. An active material obtained by calcining such particles has little structural disorder on the surface. However, as charging and discharging are repeated, the surface structure deteriorates, resulting in insufficient durability.

The present disclosure has been made in view of the above circumstances, and a main object thereof is to provide a precursor of a cathode active material that can produce a cathode active material with excellent durability.

The present disclosure includes the following aspects.
(1) A precursor of a cathode active material, the precursor including secondary particles each including a plurality of primary particles aggregated together, wherein:
the primary particles include a nickel composite hydroxide; and
the precursor includes, on at least a portion of the outermost surface of each of the primary particles as observed with a transmission electron microscope, a layer of a rock salt structure containing nickel oxide.
(2) The precursor according to (1), wherein the layer of the rock salt structure has a thickness of is 0.5 nm to 20 nm.
(3) The precursor according to (1) or (2), wherein the nickel composite hydroxide is a nickel-cobalt-manganese composite hydroxide.

The present disclosure can provide a precursor of a cathode active material that can produce a cathode active material with excellent durability.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram illustrating an example of the structure of a precursor according to the present disclosure.

### DETAILED DESCRIPTION OF EMBODIMENTS

An embodiment according to the present disclosure will now be described. It should be noted that matters not specifically mentioned in the present specification but necessary to carry out the present disclosure (for example, general configurations and production processes of a cathode active material and its precursor that are not characteristic of the present disclosure) may be understood as design matters for those skilled in the art based on conventional techniques in the art. The present disclosure may be carried out based on the content disclosed in the present specification and the common general technical knowledge in the art.

The dimensional relationships (such as length, width, and thickness) shown in the drawings do not reflect the actual dimensional relationships.

The present disclosure provides a precursor of a cathode active material. The precursor includes secondary particles each including a plurality of primary particles aggregated together. The primary particles include a nickel composite hydroxide. The precursor includes, on at least a portion of the outermost surface of each of the primary particles as observed with a transmission electron microscope, a layer of a rock salt structure containing nickel oxide (hereinafter, the “layer of the rock salt structure” will also be referred to as “rock salt structure layer”).

As described above, the precursor of the cathode active material of the present disclosure has a rock salt structure layer containing nickel oxide on at least a portion of the outermost surface of each primary particle. Accordingly, an active material obtained by calcining the precursor of the present disclosure also has a rock salt structure layer formed in advance on at least a portion of its outermost surface. Such an active material having a rock salt structure layer on its outermost surface is less likely to undergo structural disorder at its surface even when insertion and extraction of ions (e.g., lithium ions) are repeatedly performed in association with charging and discharging. Therefore, according to the present disclosure, it is possible to obtain an active material that exhibits excellent durability with suppressed deterioration even after repeated charging and discharging.

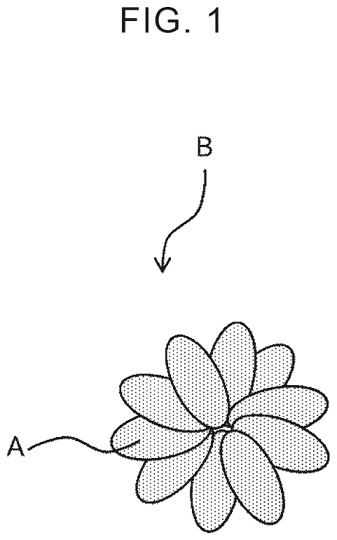

FIG. 1 is a conceptual diagram illustrating an example of the structure of the precursor according to the present disclosure. The precursor of the present disclosure includes secondary particles B each including a plurality of primary particles A aggregated together as shown in FIG. 1. In addition to the secondary particles, the precursor of the present disclosure may also include primary particles existing individually without aggregation.

In the present disclosure, the primary particles include a nickel composite hydroxide. The nickel composite hydroxide is a hydroxide containing nickel (Ni) and another metal species other than nickel. The other metal species other than nickel may be of one kind or two or more kinds. Examples of the other metal species other than nickel include manganese (Mn), cobalt (Co), and aluminum (Al). Specific examples of nickel composite hydroxides include a nickel-cobalt composite hydroxide containing nickel and cobalt, a nickel-cobalt-manganese composite hydroxide containing nickel, cobalt, and manganese, and a nickel-cobalt-aluminum composite hydroxide containing nickel, cobalt, and aluminum. The nickel composite hydroxide may be a nickel-cobalt-manganese composite hydroxide.

In these nickel composite hydroxides, the ratios (molar ratios) of nickel and the other metal species to the total amount of nickel and the other metal species are not particularly limited. In the case of a nickel-cobalt composite hydroxide, the molar ratios may be as follows. Ni/NiCo may be 0.5 or more and 1.0 or less, and Co/NiCo may be 0 or more and 0.5 or less. In the case of a nickel-cobalt-manganese composite hydroxide, the molar ratios may be as follows. Ni/NiCoMn may be 0.5 or more and 1.0 or less, Co/NiCoMn may be 0 or more and 0.3 or less, and Mn/NiCoMn may be 0 or more and 0.3 or less. In the case of a nickel-cobalt-aluminum composite hydroxide, the molar ratios may be as follows. Ni/NiCoAl may be 0.5 or more and 1.0 or less, Co/NiCoAl may be 0 or more and 0.3 or less, and Al/NiCoAl may be 0 or more and 0.3 or less.

In the present disclosure, the nickel composite hydroxide may further contain another metal species other than nickel, cobalt, aluminum, and manganese. The other metal species may include at least one selected from the group consisting of, for example, Zr, Mo, Mg, Ca, Na, Fe, Cr, Zn, Si, Sn, and Ag.

In the present disclosure, the precursor of the present disclosure has a rock salt structure layer containing nickel oxide (NiO) on the outermost surface of each primary particle when observed with a transmission electron microscope (TEM). The rock salt structure layer is typically formed of nickel oxide, but may also contain metal oxides other than nickel oxide.

Whether the rock salt structure layer contains nickel oxide can be confirmed by, for example, performing compositional analysis (elemental analysis) with energy dispersive X-ray spectroscopy (EDX) on a TEM image obtained by observing a cross section of a primary particle with a TEM. The compositional analysis may be performed by a known method. For example, scanning electron microscope (SEM)-EDX or X-ray photoelectron spectroscopy (XPS) may also be used in addition to TEM-EDX.
It is sufficient that the rock salt structure layer is present at least on a portion of the outermost surface of the primary particle. However, the rock salt structure layer may cover, for example, 50% or more of the area of the outermost surface of the primary particle. The coverage rate of the rock salt structure layer may be determined by, for example, TEM observation.

The thickness of the rock salt structure layer is not particularly limited, but may be, for example, from 0.5 nm to 20 nm, from 0.5 nm to 12 nm, or from 0.6 nm to 10.1 nm. The thickness of the rock salt structure layer herein refers to a value calculated by measuring the thickness of the rock salt structure layer on a basal plane at five locations in observation of the primary particle with a scanning transmission electron microscope (STEM) and calculating the average value.

The size of the primary particles is not particularly limited. For example, when the particles have a flat shape such as a plate or needle shape, the average value of the length in the short-side direction (thickness) may be from 10 nm to 200 nm. The size of the primary particles can be determined by, for example, measuring the thicknesses of cross sections of a plurality of primary particles in TEM images or SEM images and calculating the average value thereof.

The size of the secondary particle formed by aggregation of a plurality of such primary particles is not particularly limited. For example, the average particle size of the secondary particles may be from 4 μm to 15 μm, or may be from 4 μm to 10 μm. As in the case of the primary particles, the average particle size of the secondary particles can be determined by measuring the particle sizes of a plurality of secondary particles in TEM observation or SEM observation and calculating the average value thereof.

The method for producing the precursor of the cathode active material of the present disclosure is not particularly limited, and examples include the following method. First, a water-soluble nickel source (nickel compound) serving as a starting material of the nickel composite hydroxide, and another water-soluble metal source (such as a cobalt compound, a manganese compound, or an aluminum compound) are dissolved in deionized water to prepare an aqueous metal source solution. At this time, in the aqueous metal source solution, the ratios (mol %) of nickel and the other metal species to the total amount of nickel and the other metal species are typically adjusted to be equal to the ratios (mol %) of nickel and the other metal species in the nickel composite hydroxide to be formed. The water-soluble metal compounds are not particularly limited, and examples include sulfates. Next, a certain amount of aqueous NH₃ solution (ammonium ion donor) is placed in a reaction vessel, and while stirring with a stirrer etc., the atmosphere is purged with nitrogen to create a non-oxidizing atmosphere.

Subsequently, an aqueous sodium hydroxide solution is added to the reaction vessel, and while maintaining the pH at an alkaline level (e.g., pH 12), the aqueous metal source solution and the aqueous NH₃ solution are added dropwise into the reaction vessel. The reaction temperature is not particularly limited, and may be, for example, 60° C.

After the reaction is completed, an aging treatment is performed by oxygen bubbling. The time for the aging treatment may be set to, for example, 30 minutes to one hour.
After the aging treatment, a drying treatment is performed. For example, the drying treatment may be performed at 110° C. to 250° C. for 10 minutes to 12 hours under an inert gas atmosphere.

The precursor of the cathode active material of the present disclosure can be used as, for example, a cathode active material for a battery such as a lithium-ion battery by being converted into a lithium-nickel composite oxide.

The lithium-nickel composite oxide can be produced from the precursor of the present disclosure by, for example, the following method. The nickel composite hydroxide that is the precursor of the present disclosure is mixed with a lithium compound serving as a lithium source, and the obtained mixture is calcined.

The lithium compound may be, for example, at least one selected from lithium carbonate, lithium nitrate, lithium acetate, lithium hydroxide, lithium oxide, and lithium chloride.

The ratio of the lithium compound to the precursor in the mixture is typically adjusted such that the ratios (mol %) of lithium and the other metal species to the total amount of lithium and the other metal species in the target cathode active material becomes equal to the ratios (mol %) of lithium and the other metal species in the mixture. The mixing method is not particularly limited, and any known method may be used.

The obtained mixture is calcined, for example, at 700° C. to 950° C. for eight hours to 15 hours. A lithium-nickel composite oxide can thus be obtained. Known calcination furnaces such as a muffle furnace can be used for the calcination.

The cathode active material obtained by calcining the precursor of the present disclosure is generally considered to be composed of single-crystal particles.
As used herein, the “single-crystal particle” refers to a single particle that does not form a secondary particle and that is substantially composed of a single crystal. Whether the particles are single-crystal particles can be confirmed by the absence of grain boundaries in an SEM image.

The precursor of the cathode active material provided by the present disclosure can be used as, for example, a precursor of a cathode active material constituting the cathode of a battery (such as a lithium-ion battery). That is, the present disclosure can provide a battery in which a cathode, an electrolyte layer, and an anode are stacked in this order and the cathode contains a cathode active material obtained from the precursor of the present disclosure.

The battery will now be described.

The cathode includes a cathode layer, and may further include a cathode current collector.

The cathode layer is a layer containing at least a cathode active material. The cathode active material may solely contain the cathode active material obtained from the precursor of the present disclosure, or may further contain another active material. The content of the cathode active material in the cathode layer is not particularly limited, and may be, for example, from 20 mass % to 80 mass %.
The cathode layer may further contain at least one of the following: an electrolyte, an electrically conductive material, and a binder.
Examples of electrolytes include solid electrolytes. The solid electrolyte may be an inorganic solid electrolyte such as a sulfide solid electrolyte, a halide solid electrolyte, an oxide solid electrolyte, or a complex hydride solid electrolyte, or may be an organic solid electrolyte such as a gel electrolyte. The proportion of the solid electrolyte in the cathode layer may be, for example, from 10 mass % to 60 mass %.
Examples of electrically conductive materials include carbon materials, metal particles, and electrically conductive polymers. Examples of carbon materials include particulate carbon materials such as acetylene black (AB) and Ketjen black (KB), and fibrous carbon materials such as vapor-grown carbon fibers (VGCFs), carbon nanotubes (CNTs), and carbon nanofibers (CNFs). The proportion of the electrically conductive material in the cathode layer may be, for example, from 0.1 mass % to 5 mass %.
Examples of binders include styrene-butadiene rubber (SBR), acrylonitrile-butadiene rubber (NBR), butadiene rubber (BR), polyvinylidene fluoride (PVDF), polytetrafluoroethylene (PTFE), styrene-isoprene-styrene block copolymers (SISs), and ethylene-propylene-diene copolymers (EPDMs). The proportion of the binder in the cathode layer may be, for example, from 0.5 mass % to 5 mass %.
Examples of materials for the cathode current collector include SUS, Cr, Au, Pt, Zn, aluminum, copper, nickel, iron, titanium, and carbon. The thickness of the cathode current collector is, for example, 0.1 μm or more and 100 μm or less. The cathode current collector may be in the form of a foil or a plate. The shape of the cathode current collector as viewed in plan is not particularly limited, and examples include circular, elliptical, rectangular, and any polygonal shapes. The cathode current collector may have a structure in which a buffer layer, an elastic layer, or a positive temperature coefficient (PTC) thermistor layer is provided on its surface.

The anode includes an anode layer, and may further include an anode current collector.

The anode layer is a layer containing at least an anode active material. The anode layer may further contain at least one of the following: an electrolyte, an electrically conductive material, and a binder. Examples of anode active materials for lithium-ion batteries include carbon materials such as natural graphite, lithium metal, and lithium alloys.
The electrolyte, electrically conductive material, and binder used in the anode layer may be the same as those described above for the cathode layer.
Examples of materials for the anode current collector include SUS, aluminum, copper, nickel, iron, titanium, and carbon. The thickness of the anode current collector is, for example, 0.1 μm or more and 100 μm or less. The anode current collector may be in the form of a foil or a plate. The shape of the anode current collector as viewed in plan is not particularly limited, and examples include circular, elliptical, rectangular, and any polygonal shapes. The anode current collector may have a structure in which a buffer layer, an elastic layer, or a PTC thermistor layer is provided on its surface.

The electrolyte layer is a layer formed between the cathode layer and the anode layer and contains at least an electrolyte. Examples of electrolytes include electrolyte solutions in addition to the solid electrolytes described above for the cathode layer.

The electrolyte solution may be an aqueous electrolyte solution or a non-aqueous electrolyte solution. One kind of electrolyte solution may be used alone, or two or more kinds of electrolyte solutions may be used in combination.

The solvent of the aqueous electrolyte solution contains water as a main component. That is, based on the total amount (100 mol %) of the solvent (liquid component) constituting the electrolyte solution, the proportion of water may be 50 mol % or more, particularly 70 mol % or more, and more particularly 90 mol % or more. There is no particular upper limit to the proportion of water in the solvent.

Although the solvent contains water as a main component, it may also contain a solvent other than water. The solvent other than water is, for example, one or more selected from ethers, carbonates, nitriles, alcohols, ketones, amines, amides, sulfur compounds, and hydrocarbons. Based on the total amount (100 mol %) of the solvent (liquid component) constituting the electrolyte solution, the proportion of solvents other than water may be 50 mol % or less, particularly 30 mol % or less, and more particularly 10 mol % or less.

The aqueous electrolyte solution contains an electrolyte. A conventionally known electrolyte may be used as the electrolyte for the aqueous electrolyte solution. Examples of electrolytes include lithium salts of imide compounds, lithium nitrates, lithium acetates, and lithium sulfates. Specific examples of electrolytes include lithium bis(fluorosulfonyl)imide (LiFSI), lithium bis(trifluoromethanesulfonyl)imide (LiTFSI), lithium bis(pentafluoroethanesulfonyl)imide (LiBETI), lithium bis(nonafluorobutanesulfonyl)imide, lithium nonafluoro-N-[(trifluoromethane)sulfonyl]butanesulfonylamide, lithium N,N-hexafluoro-1,3-disulfonylimide, CH₃COOLi, LiPF₆, LiBF₄, Li₂SO₄, and LiNO₃.

The concentration of the electrolyte in the aqueous electrolyte solution can be set as appropriate within a range that does not exceed the saturation concentration of the electrolyte in the solvent, according to desired battery characteristics. This is because, if a solid electrolyte remains in an aqueous electrolyte solution, the solid may inhibit battery reactions.

For example, when the electrolyte is LiTFSI, the aqueous electrolyte solution may contain 1 mol or more, particularly 5 mol or more, more particularly 7.5 mol or more of LiTFSI per kilogram of water. There is no particular upper limit to the concentration of the electrolyte. For example, the concentration of the electrolyte may be 25 mol or less.

An electrolyte solution containing a lithium salt and a non-aqueous solvent is usually used as a non-aqueous electrolyte solution.

Examples of the lithium salt include: inorganic lithium salts such as LiPF₆, LiBF₄, LiClO₄, and LiAsF₆; and organic lithium salts such as LiCF₃SO₃, LiN(SO₂CF₃)₂(Li-TFSI), LiN(SO₂C₂F₅)₂, and LiC(SO₂CF₃)₃.
Examples of non-aqueous solvents include ethylene carbonate (EC), propylene carbonate (PC), butylene carbonate (BC), dimethyl carbonate (DMC), diethyl carbonate (DEC), ethyl methyl carbonate (EMC), γ-butyrolactone, sulfolane, acetonitrile (AcN), dimethoxymethane, 1,2-dimethoxyethane (DME), 1,3-dimethoxypropane, diethyl ether, tetraethylene glycol dimethyl ether (TEGDME), tetrahydrofuran, 2-methyl tetrahydrofuran, dimethyl sulfoxide (DMSO), and mixtures thereof. From the standpoint of ensuring high dielectric constant and low viscosity, the non-aqueous solvent may be a mixture of a cyclic carbonate compound having a high dielectric constant and high viscosity such as EC, PC, or BC and a chain carbonate compound having a low dielectric constant and low viscosity such as DMC, DEC, or EMC, or may be a mixture of EC and DEC.
The concentration of the lithium salt in the non-aqueous electrolyte solution may be, for example, from 0.3 M to 5 M.

The non-aqueous electrolyte solution may include an ionic liquid. The ionic liquid may include at least one selected from the group consisting of sulfonium salts, ammonium salts, pyridinium salts, piperidinium salts, pyrrolidinium salts, morpholinium salts, phosphonium salts, imidazolium salts, and derivatives thereof.

The electrolyte layer may include a separator impregnated with the above electrolyte solution and configured to isolate the cathode layer from the anode layer. The material of the separator is not particularly limited as long as it is a porous membrane, and examples include resins such as polyethylene (PE), polypropylene (PP), polyester, polyvinyl alcohol, cellulose, and polyamide. Among these, polyethylene and polypropylene may be used. The separator may have a single-layer structure or a multilayer structure. Examples of separators having a multilayer structure include a separator having a two-layer structure of PE/PP, and a separator having a three-layer structure of PP/PE/PP or PE/PP/PE. The separator may be a nonwoven fabric such as a resin nonwoven fabric or a glass fiber nonwoven fabric.

The battery may further include a restraining jig that applies a restraining pressure along the thickness direction to the cathode layer, the electrolyte layer, and the anode layer. The restraining pressure may be, for example, from 0.1 MPa to 100 MPa. The type of the battery is not particularly limited, and is generally a battery in which metal ions conduct between the cathode layer and the anode layer. Examples of such a battery include a lithium-ion battery. The battery may be either a primary battery or a secondary battery, but may particularly be a secondary battery. This is because it can be repeatedly charged and discharged and is useful, for example, as an in-vehicle battery.

The shape of the battery is not particularly limited. For example, the battery may be a coin battery, a cylindrical battery, a prismatic battery, a sheet battery, a button battery, a flat battery, or a laminated battery.

Examples of applications of the battery include power supplies for vehicles such as hybrid electric vehicles (HEVs), plug-in hybrid electric vehicles (PHEVs), battery electric vehicles (BEVs), gasoline vehicles, and diesel vehicles. In particular, the battery may be used as a drive power supply for hybrid electric vehicles (HEVs), plug-in hybrid electric vehicles (PHEVs), or battery electric vehicles (BEVs). The battery may also be used as a power supply for moving objects other than vehicles (for example, trains, ships, and aircraft), or as a power supply for electrical products such as information processing devices.

### Synthesis of Precursor of Cathode Active Material

### Examples 1 to 3

NiSO₄, CoSO₄, and MnSO₄ were dissolved in deionized water to prepare an aqueous metal source solution. The Ni/Co/Mn ratio in the aqueous metal source solution was set to 80/10/10 in mol %. The concentration of the aqueous metal source solution (the proportion of all the metal sources in the aqueous metal source solution) was set to 1.5 mol %. A certain amount of NH₃ aqueous solution was placed in a reaction vessel, and while stirring with a stirrer, the inside of the reaction vessel was purged with nitrogen. An aqueous NaOH solution was then added to the reaction vessel, and while maintaining the pH at an alkaline level (pH=12), the aqueous metal source solution and the aqueous NH₃ solution were added dropwise into the reaction vessel. The reaction temperature was 60° C., and the reaction time was 10 hours.

After completion of the reaction, an aging treatment was performed under the conditions shown in Table 1. Thereafter, a drying treatment was performed under the conditions shown in Table 1 under an inert gas atmosphere.

TABLE 1

| | Aging Treatment | Drying Treatment |
|---|---|---|
| | Conditions | Conditions |
| Example 1 | 30 minutes with oxygen bubbling | 110° C., 12 hours |
| Example 2 | 30 minutes with oxygen bubbling | 220° C., 10 minutes |
| Example 3 | One hour with oxygen bubbling | 250° C., 10 minutes |
| Comparative | Not performed | 110° C., 12 hours |
| Example 1 | | |

Observation of the surface of each obtained precursor with TEM confirmed the presence of a rock salt structure layer on the outermost surface of each of the precursors of Examples 1 to 3.

Observation of a cross section of each precursor with STEM also confirmed that the rock salt structure layer contained nickel oxide (NiO). In addition, in a STEM image, the thickness of the rock salt structure layer on a basal plane was measured at five locations, and the average value was calculated as the thickness of the rock salt structure layer. The results are shown in Table 2.

### Comparative Example 1

A precursor of a cathode active material was synthesized in the same manner as in Example 1 except that no aging treatment was performed after completion of the reaction and a drying treatment was performed for 12 hours at 110° C. under an inert gas atmosphere.

The obtained precursor was observed with TEM and STEM in the same manner as in the examples. No presence of a rock salt structure layer containing nickel oxide was confirmed on the outermost surface of the precursor.

### Synthesis of Cathode Active Material

Each of the precursors of Examples 1 to 3 and Comparative Example 1 synthesized as described above and a lithium compound (LiOH) serving as a lithium source were mixed in a mortar. Each of the resulting mixtures was calcined in a calcination furnace at 950° C. for 10 hours to synthesize cathode active materials (LiNi_{0.8}Co_{0.1}Mn_{0.1}O₂) of Examples 1 to 3 and Comparative Example 1.

### Cell Fabrication

Small laminate cells of Examples 1 to 3 and Comparative Example 1 were fabricated using the cathode active materials of Examples 1 to 3 and Comparative Example 1, respectively.

Specifically, a cathode composite paste containing the cathode active material and acetylene black as an electrically conductive material was applied to the surface of a metal foil serving as a cathode current collector using a film applicator with a thickness adjustment function (manufactured by Allgood Co., Ltd.). The coating was then dried at 80° C. for five minutes in a dryer to prepare a cathode having a cathode layer on the cathode current collector. Meanwhile, an anode composite paste containing natural graphite as an anode active material was applied to the surface of a metal foil serving as an anode current collector using a film applicator with a thickness adjustment function (manufactured by Allgood Co., Ltd.). The coating was then dried at 80° C. for five minutes in a dryer to prepare an anode having an anode layer on the anode current collector.
A 1 M LiPF₆ solution containing LiPF₆ as an electrolyte and ethylene carbonate (EC), dimethyl carbonate (DMC), and ethyl methyl carbonate (EMC) as a solvent in a volume ratio of EC/DMC/EMC=3/4/3 vol % was prepared as an electrolyte solution.
The cathode, a separator, and the anode were stacked, and the separator was impregnated with the electrolyte solution. The small laminate cells of Examples 1 to 3 and Comparative Example 1 were thus fabricated.

### Cell Evaluation

For each of the fabricated small laminate cells, the discharge capacity was measured before and after a cycle test. The cycle test was conducted for 200 cycles under the following conditions.

### Discharge Capacity Measurement Conditions

C-rate: 0.1 C
Measurement mode: CC-CV discharge
Temperature: 25° C.

### Cycle Test Conditions

C-rate: 0.3 C
Mode: CC charge/discharge
Temperature: 50° C.

From the discharge capacity values measured before and after the cycle test, the capacity retention after the cycle test was calculated using the following equation. The results are shown in Table 2.

$$Capacity retention ( \% ) = ( Capacity after cycle test ) / ( Capacity before cycle test ) \times 100$$

TABLE 2

| | Presence/Absence of | Thickness of NiO- | Capacity |
|---|---|---|---|
| | NiO-Containing | Containing Rock | Retention |
| | Rock Salt | Salt Structure | After Cycle |
| | Structure Layer | Layer (nm) | Test (%) |
| Example 1 | Present | 0.6 | 91 |
| Example 2 | Present | 2.5 | 95 |
| Example 3 | Present | 10.1 | 95 |
| Comparative | Absent | — | 75 |
| Example 1 | | | |

As shown in Tables 1 and 2, comparison between Comparative Example 1 and Example 1 shows that, in the synthesis of the precursor of the cathode active material, performing the aging treatment enables formation of a rock salt structure layer containing nickel oxide on the outermost surface of the precursor.

As shown in Tables 1 and 2, comparison between Example 1 and Example 2 shows that, in the synthesis of the precursor of the cathode active material, when the aging treatment conditions are the same, changing the drying treatment conditions from 110° C. for 12 hours to 220° C. for 10 minutes makes it possible to increase the thickness of the rock salt structure layer.
As shown in Tables 1 and 2, comparison between Example 2 and Example 3 shows that, in the synthesis of the precursor of the cathode active material, changing the aging treatment time from 30 minutes to one hour and changing the drying treatment conditions from 220° C. for 10 minutes to 250° C. for 10 minutes makes it possible to further increase the thickness of the rock salt structure layer.
From the above, it can be seen that performing the aging treatment enables formation of a rock salt structure layer containing nickel oxide on the outermost surface of the precursor. It can also be seen that either increasing the aging treatment time or increasing the drying treatment temperature, or both, makes it possible to increase the thickness of the rock salt structure layer. In addition, it can be seen that increasing the drying treatment temperature enables formation of the rock salt structure layer in a shorter time.
As shown in Table 2, Examples 1 to 3, in which precursors having a rock salt structure layer containing NiO on their outermost surface were used, exhibited significantly improved capacity retention compared with Comparative Example 1, in which a precursor having no rock salt structure layer containing NiO on its outermost surface was used. In particular, the precursors of Examples 2 and 3, in which the thicknesses of the rock salt structure layer containing NiO were 2.5 nm and 10.1 nm, respectively, exhibited an improvement in capacity retention by 20% or more over Comparative Example 1.

What is claimed is:

1. A precursor of a cathode active material, the precursor comprising
secondary particles each including a plurality of primary particles aggregated together, wherein:
the primary particles include a nickel composite hydroxide; and
the precursor includes, on at least a portion of an outermost surface of each of the primary particles as observed with a transmission electron microscope, a layer of a rock salt structure containing nickel oxide.

2. The precursor according to claim 1, wherein the layer of the rock salt structure has a thickness of 0.5 nm to 20 nm.

3. The precursor according to claim 1, wherein the nickel composite hydroxide is a nickel-cobalt-manganese composite hydroxide.
